(19) United States
(12) Patent Application Publication
(10) Pub. No.: US 2002/0077863 A1
(43) Pub. Date: Jun. 20, 2002

(54) System and method for processing patient medical information acquired over a plurality of days

(76) Inventors: Jolyn Rutledge, Amesbury, MA (US); Rand Monteleone, Acton, MA (US)

Correspondence Address: Siemens Corporation, Intellectual Property Department, 186 Wood Avenue South, Iselin, NJ, 08830, US

(21) Appl. No.: 09/991,118

(22) Filed: Nov. 16, 2001

Related U.S. Application Data
(60) Provisional application No. 60/249,577, filed on Nov. 17, 2000.

(51) Int. Cl. G06F 17/60

(52) U.S. Cl. 705/3

(57) ABSTRACT

An internet compatible system and method are presented for displaying medical information derived from a plurality of sources. Medical parameters associated with a patient are collected via a communication network, collated and stored in a relational database. A display generator responsive to a user selection operates to generate a display containing acquired patient medical data in a predetermined format along a timeline. A day indicator associated with the displayed patient medical data indicates a currently selected day and at least one of a prior day and a subsequent day relative to the currently selected day. The current day indicator has a display attribute for distinguishing between the prior or subsequent day. The timeline uses the display attribute to distinguish portions of the timeline associated with the current day from a prior or subsequent day. The displayed patient medical data includes particular medical parameters that are acquired within the selected day range and displayed in a desired order together with the timeline.

### CROSS REFERENCE TO RELATED APPLICATION

This application claims the benefit of provisional U.S. application, U.S. Ser. No. 60/249,577 filed Nov. 17, 2000.

### FIELD OF THE INVENTION

This invention is related to the processing and displaying of medical information, and more particularly to processing and displaying of patient medical data in a network environment.

### BACKGROUND OF THE INVENTION

In hospitals and other health care environments, it is often necessary or desirable to collect and display a variety of medical data associated with a patient. Such information may include laboratory test results, care unit data, diagnosis and treatment procedures, ventilator information, attending physician or health care provider, and calendar information associated with a given patient. Presently, such information is often provided via a chart attached to a patient's bedside or at an attendant's station. However, such physical charts are cumbersome to view, and often do not include the most up-to-date medical information associated with the patient, such as laboratory test results. This problem is exacerbated due to the large amount of patient data that accumulates during a patient's stay in the hospital. Traditional paper-based charts for displaying patient medical data including chronological or timeline information are particularly cumbersome to view, difficult to organize and susceptible to page loss or misplacement. Additional problems related to the timeliness of such chart information arise from the fact that medical data often arrives from multiple sources and at various times. Furthermore, present charts are not adapted to enable a care giver to easily access, view, or determine the results of multiple medical tests or other data associated with the patient. Consequently, a need exists for a faster, more effective and user friendly means for accessing, manipulating and displaying patient medical information including timeline information derived from a plurality of sources.

### SUMMARY OF THE INVENTION

An internet compatible system and method are presented for displaying medical information derived from a plurality of sources. Medical parameters associated with a patient are collected via a communication network, collated and stored in a relational database. A display generator responsive to a user selection operates to generate a display containing acquired patient medical data in a predetermined format along a timeline. A day indicator associated with the displayed patient medical data indicates a current day and at least one of a prior day and a subsequent day relative to the current day. The current day indicator has a display attribute for distinguishing between the prior or subsequent day. The timeline uses the display attribute to distinguish portions of the timeline associated with the current day from a prior or subsequent day. The displayed patient medical data includes particular medical parameters that are acquired within the selected day range and displayed in a desired order together with the timeline.

The communication network acquires the patient medical data from a plurality of sources using various network protocols; such protocols include ASTM and HL7 protocols for interfacing with local and wide area networks and peripheral medical devices. The displayed patient medical data includes particular medical parameters associated with certain medical categories such as cardiology, lab results, hemodynamic, ventilation and neurology acquired within a predetermined day range that includes the user selected day. The display includes a scroll bar for viewing a set of displayed medical parameter data larger than can be fit within the given display area. The user interface apparatus further includes a user selectable timeline interval discriminator for scaling the displayed timeline at predetermined intervals ranging from 15 minute intervals to eight hour intervals.

In another aspect, the system of the present invention continuously acquires additional medical information associated with patients for display in a composite window. The medical data is displayed in either a tabular or graphical format and includes particular medical parameters acquired within a selected day range and formatted along a timeline in a desired order. The display further includes color attributes associating the selected day parameter data with corresponding portions of the timeline to differentiate data across day boundaries. This is advantageous for automatically providing a user-selectable history of patient information displayable in a manner that optimizes trend analysis and evaluation of patient parameter data.

### BRIEF DESCRIPTION OF THE DRAWINGS

In the drawings, wherein like reference numerals are used to indicate like parts:

FIG. 1 is a block diagram of a communication network with various devices, according to the principles of the invention.

FIG. 2 represents a flow diagram of a system according to the present invention.

FIG. 3 shows an exemplary way of how medical parameter data are displayed in tabular format along a timeline selectable by a user according to an aspect of the present invention.

FIG. 4 shows an exemplary way of how medical parameter data are displayed in graphical format along a timeline selectable by a user according to an aspect of the present invention.

FIG. 5 is a block diagram of a server having functionality in accordance with the present invention.

### DETAILED DESCRIPTION

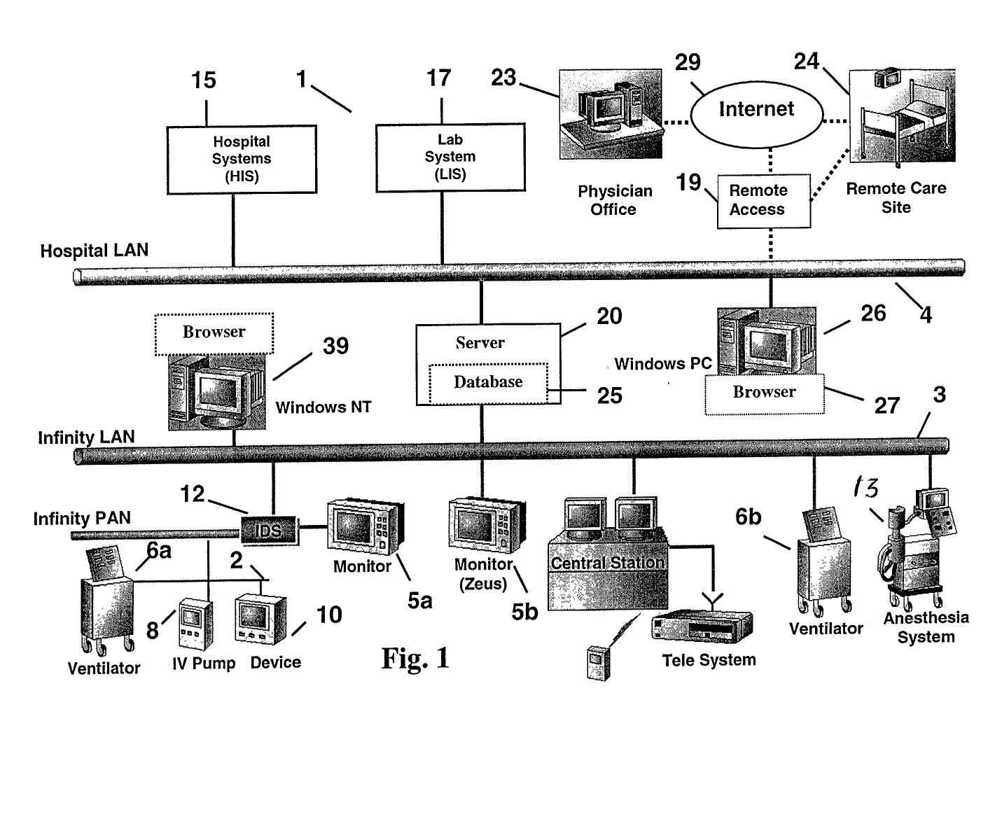

FIG. 1 is an exemplary block diagram of a communication network according to the principles of the present invention. As shown in FIG. 1, communication network 1 is represented by an IP (Internet Protocol) compatible network with a hierarchy of local area and wide area networks interconnected together. It is to be noted that although the present exemplary hospital or medical network is an IP compatible network, other types of networks such as, but not limited to optical or wireless networks, using other computing protocols such as, but not limited to, for example, X0.25, frame relay, IBM SNA etc., may also be used, as one skilled in the art can readily appreciate. In addition, although the exemplary network described is a hierarchical network, this is not required by the present invention. Any type of network architecture that provides communication connectivity among the devices on the network may be used.

As shown on FIG. 1, the first level of the exemplary hierarchical network 1 comprises a Medical Interface Bus (MIB) 2. A MIB is a well-known medical industry standard for locally connecting medical devices together. As shown in FIG. 1, MIB 2 is typically used to interconnect medical devices in a patient's room to administer care to a particular patient and to monitor the particular patient. Various medical devices may be connected via MIB 2; examples shown in FIG. 1 comprise a ventilator 6a, IV (Intravenous) Pump 8 or other medical equipment 10.

MIB 2 is typically connected to a second level LAN network 3 through an Interface Docking Station (IDS) device 12, for interfacing to Ethernet-compatible LAN network 3. The higher-level LAN 3 may be for example, an Infinity LAN, marketed by Siemens Medical System. This higher-level LAN 3 is typically, though not necessarily, used by a particular department within a hospital, such as an intensive care department or surgery department, etc., depending on the size of the organizations.

Although not shown in FIG. 1, more than one MIB may be connected to the second level LAN 3, so that more than one patient may be monitored or given care through LAN 3. In addition, medical devices may be connected directly to higher-level LAN 3. For example, as shown in FIG. 1, a ventilator 6b and an anesthesia system 13 are connected directly to LAN 3, without the need to go through a MIB.

Furthermore, LAN 3 may be interconnected to a Hospital LAN backbone 4 which also is Ethernet compatible. This backbone network 4 provides communication connectivity between various departments within a hospital or medical organization; for example, connecting hospital administrative systems 15 together with laboratory systems 17. In addition, the Hospital LAN 4 has a remote access gateway 19 which provides remote, secured access from, for example, a remote doctor's office 23 or a remote care site 24, to the various systems and devices on network 1, through for example, Internet 29. Alternatively, a remote site may also access the remote access gateway 19 directly through, for example, a dial-up telephone port, ADSL, or other types of private connection. Remote access gateway 19 may also be part of server 20, to be described below, instead of standing alone, as well know in the art.

According to the principles of the present invention, a central server 20 resides on LAN 3 for gathering and processing data from the peripheral medical devices or facilities coupled to LAN 3 or hospital LAN 4, including medical parameters such as lab results supplied via lab system 17 connected through an HL7 interface, for example. Additional medical parameter data including cardiology, hemodynamic, ventilation and neurology category data may also be acquired from any number of medical devices such as those shown in FIG. 1 and may be obtained at server 20 using various interface protocols such as ASTM messaging, for example. The acquired medical parameters associated with a given patient, including laboratory test results, are acquired from the medical devices on network 1 for display and control. One skilled in the art can readily recognize that server 20 may reside at any level of the hierarchy of network 1, since all the different levels of LANs (e.g., 3, or 4), as well 25 as remote sites in FIG. 1 are interconnected together. An example of server 20, is a Prometheus server, marketed by Siemens Medical System. The server may be hosted, for example, by a computer system that is capable of running Microsoft NT operating system.

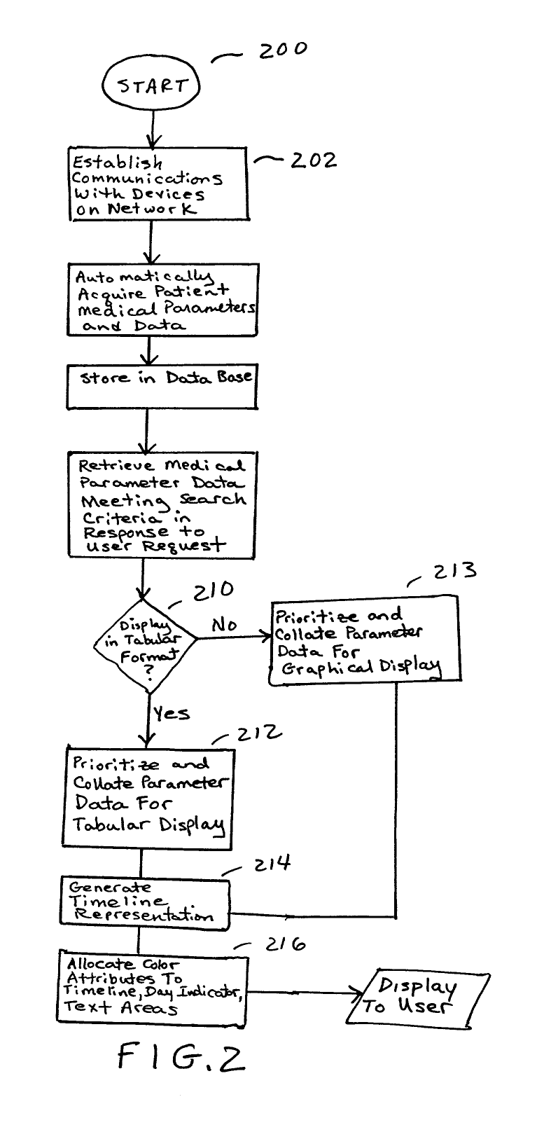

FIG. 2 shows in flow chart form, functions that may be performed by server 20 in conjunction with the user interface software resident on the web browser in accordance with the present invention. Server 20 first establishes communications with devices on the network as shown in step 202. This is done, for example, by using IP protocol and the known IP device address for each device on the network 1, in conjunction with any higher application-layer protocols, as well known in the art.

Once communications are established between server 20 and the other devices, server 20 starts to acquire parameters that are being monitored and settings selected for the various devices. This information is stored in a data base. As previously mentioned, such parameter data may be obtained through an HL7 interface with LIS 17, or via ASTM or MIB point of care (POC) medical devices depicted in FIG. 1.

Medical parameter data including cardiology, lab results, hemodynamic, ventilation and neurology category data may be continuously or periodically acquired and correlated with a given patient for storage in relational data base 25 within server 20. Data base 25 may be of the type used for storing relational data such as the Microsoft SQL server. The acquired data may include time stamp information or other information indicative of the date and time associated with the acquired data.

In one aspect of the present invention, a user may use a Microsoft Windows compatible PC 26 or Windows NT compatible PC 39 as shown in FIG. 1, or any other computers capable of running a menu generating program such as a web browser program (e.g., Microsoft Internet Explorer or Netscape Navigator, etc.) to view medical parameter data including cardiology or lab results information associated with a given patient. That is, a user may use a web browser on any computer, as long as a communication connection can be made to server 20, to make request and view information acquired and stored in data base 25. This is advantageous, since a doctor may for example, gain access to medical parameter data from, for example, a remote physician's office 23, without having to access a dedicated terminal. Of course, a user can simply use a keyboard and/or a mouse or any other user interface devices to enter a user selection or request on a user computer, as is known in the art. The user interface contains functionality for displaying medical data along a timeline in response to a particular day selection where the displayed data has attributes for distinguishing between day boundaries as well as formatting of the displayed data.

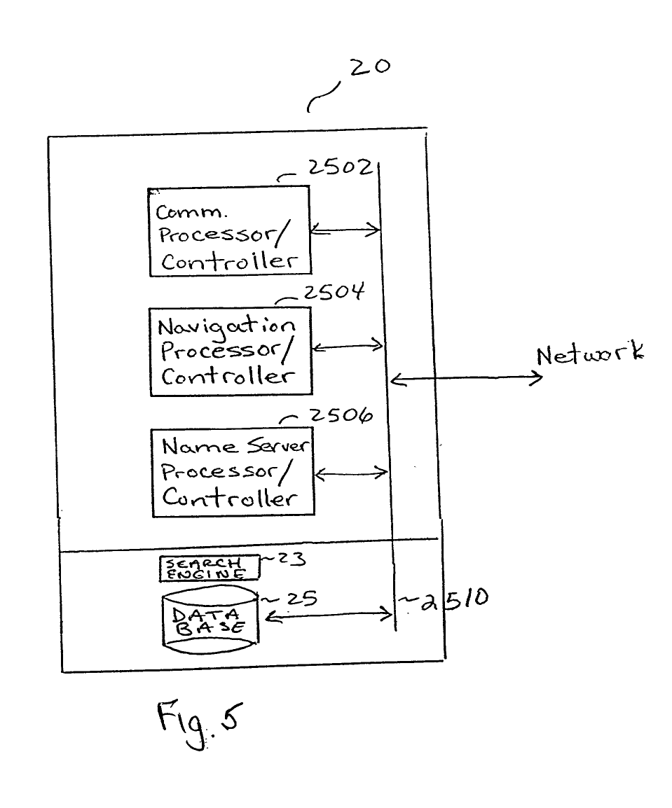

Server 20 is therefore capable of collating and formatting medical data to be compatible with, for example, HTML (HyperText Mark-up Language) programming language for displaying data on a web browser having a graphical user interface (GUI) component. The server is also responsive to, for example, HTTP (HyperText Transfer Protocol) commands originated from a user's web browser for making a request. FIG. 5 shows a block diagram of an exemplary embodiment of the server 20 which operates to manage, collate, search and update the data base 25 containing patient medical information. -Program elements or processors operative to carry out instructions for performing the various functions described herein include communications processing module 2502 that acquires the patient data including the monitored parameters and group identifiers allocated to patient groupings from the network and collates the information for storage in data base 25. Navigation collation processor 2504 operates in conjunction with the web browser and display generator software to provide and prioritize parameters for display to the user while navigating through various applications selected by a user through the user interface. Name server processor 2506 associates unique identifiers (Ids) with each node connected to the system network and with each patient in the system in order to track and update patient information throughout the system. Input/output data and control signals are used to communicate between the various processors as well as to interface with the data base 25 and search engine 23 and with the network via communication line 2510.

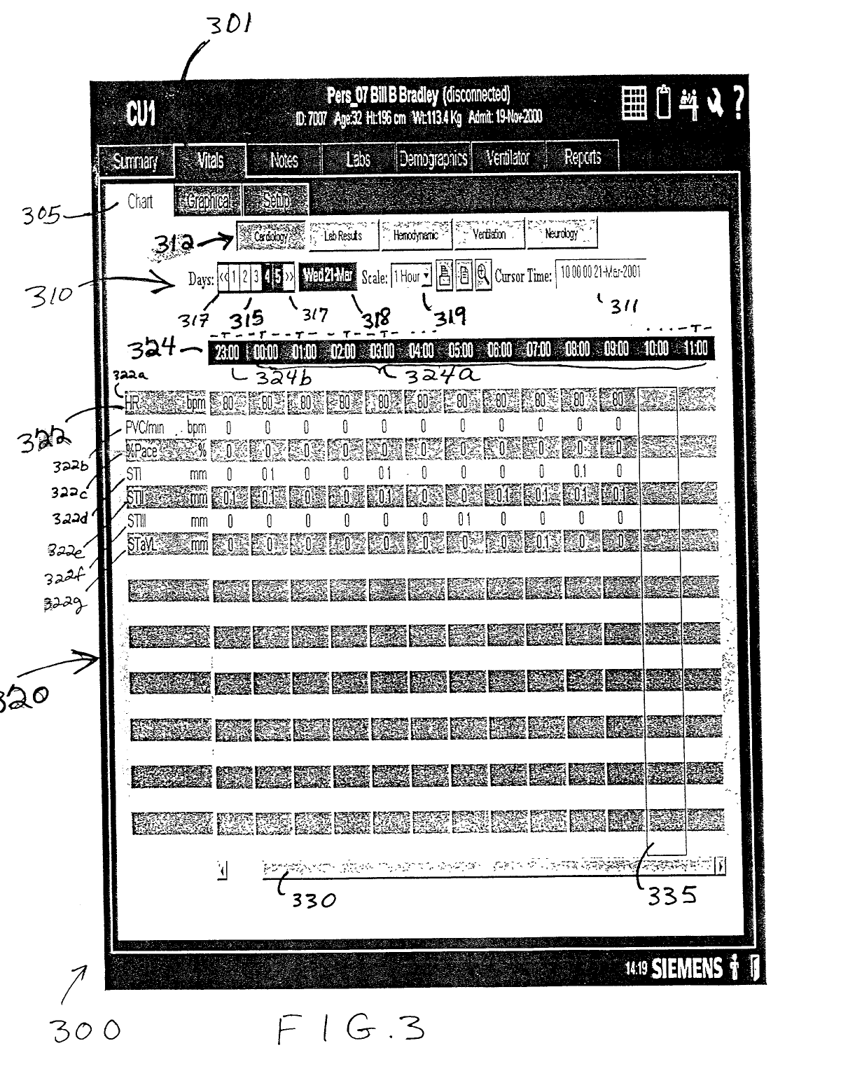

FIG. 3 shows an example of how medical parameter data associated with particular monitored parameters may be retrieved and displayed on a web browser of a user computer 26 along a timeline spanning multiple days to enable a user of the system to view trend information, according to the present invention. As shown, a display window 300 comprises a navigator panel portion 310 and a results display window portion 320. Display window 320 contains particular medical parameter data 322 displayed in a predetermined format along a timeline 324 in response to a user request for access to particular medical parameter data associated with a given patient. In the exemplary embodiment shown in FIG. 3, the medical parameter data is displayed in display window 320 in tabular or chart format when the user selects chart icon 305 from the vitals panel 301. Selection of one of the icons labeled generally as 312 and corresponding to particular medical parameters associated with a corresponding one of cardiology, lab results, hemodynamic, ventilation and neurology categories causes the user interface to request a search of the data base to obtain those particular medical parameters within the category selected. Due to the large amount of patient data that accumulates during a patient's stay in the hospital, an undesirably large amount of medical parameter data meeting the search criteria may be displayed to the user. Advantageously, the user interface apparatus according to the present invention further restricts the medical parameter data displayed to a subset of that data corresponding to a user selected date range, which is then displayed along timeline 324.

Display navigator panel 310 comprises a scrollable, user selectable day indicator panel 315 containing the entire number of days (i.e. calendar days) that a patient has been admitted according to the data base information associated with that given patient. In an exemplary embodiment, five days (1, 2, 3, 4, 5) are displayed via day indicator panel 315 with directional control selectors 317 embodied in the form of left and right arrow buttons on either side of the display indicator panel to enable a user to scroll through the entire range of days. User selection of a particular day within the day indicator panel day range causes the search engine to retrieve from the data base all medical parameter data for a given patient associated with the selected day, the immediately preceding day, and immediately succeeding day, that also meet all other search criteria (e.g. category of medical parameter data).

As shown in FIG. 3, medical parameter data 322 is displayed to the user in tabular form across day boundaries in response to user selection of a particular day (e.g. Day 5) within day indicator panel 315. The user interface operates to generate a timeline display 324 having a first portion 324a associated with the current or selected day and a second portion 324b associated with the previous or next day. In a particular embodiment, the timeline 324 is segmented into predetermined intervals T of equal duration. These intervals are scalable in user selectable increments of 15 minutes, 1 hour, 2 hours, 4 hours or 8 hours based on user selection of scale panel 319 and formatted for display in window 320. The timeline display includes indicia in hour/minute (hh:mm) format enabling a user to identify the particular time associated with particular corresponding displayed parameter data, as well as enabling a user to view or determine trends associated with the patient medical data. The retrieved medical data is prioritized, collated and displayed in a desired order in accordance with the search criteria. In the embodiment shown in FIG. 3, medical parameters 322a-322g comprising Heart Rate (HR) PVC/min, % Pace, STI, STII, STIII and STaVL are displayed in descending order along a first column while the corresponding data associated with each of the parameters are displayed in time sequence fashion along the horizontal or row. The data is aligned with the timeline display to associate a temporal period with a given column's parameter data. The right most data displayed via the web browser represents the most recent medical parameter data. The system is also operative to provide a separate cursor time display window 311 responsive to user selection of a given column 335 for displaying the date and time associated with the position of the cursor.

Horizontal scrollbar 330 positioned at the bottom of the display enables a user to view additional timeline data that cannot fit within the viewable display, due for example to the interval scaling. A vertical scrollbar (not shown) enables a user to view additional medical parameter data having rows extending beyond the page limit of the user interface. In similar fashion, the user interface apparatus may include a page up/down feature to enable a user to quickly access particular pages of displayed information viewable on display 300.

As part of the user interface apparatus of the present invention, a software module or wizard operative for displaying window 300 to the user includes logic for allocating a display attribute to the current or selected day within the day indicator panel 315. In an exemplary embodiment of the invention, the display attribute comprises a color, but may also be a text or symbol, a geometric shape or style, or a font type, for example. As shown in the exemplary embodiment of FIG. 3, the selected day (i.e. Day 5) has a blue background, while the immediately adjacent day (e.g. Day 4) for which medical parameter data exists is displayed having a black background. Days for which no data is displayed (e.g. Days 1,2,3) are displayed having a white background. A text area 318 adjacent the day indicator panel 315 displays calendar date information associated with the currently selected day. In an exemplary embodiment, the calendar date information includes the particular day of the week (e.g. Sun.-Sat.), month, and date. Advantageously, the background associated with text area 318 has the same display attribute (e.g. the same blue color) as the currently selected day.

The timeline display portion 324a associated with the currently selected day is distinguishable from portion 324b associated with the previous and/or subsequent day due to its use of the display attribute. In an exemplary embodiment, the background of the timeline display matches with the background of the day indicator panel for the corresponding day. For example, as shown in FIG. 3, display portion 324a includes a blue background attribute corresponding to the blue background attribute of the currently selected day, while display portion 324b includes a black background corresponding to the black background attribute of the succeeding day (i.e. Day 5). As discussed above, given the large amount of patient data that can exist for the patient's length of stay, it is not feasible to download the entire data set to the browser. Similarly, due to the continuous nature of the data being viewed, allowing the user to view data one day at a time is most inefficient. The user interface apparatus of the present invention overcomes these difficulties by providing a scrollable window display extending beyond a single day (i.e. 24 hour period) while allowing a user to select a desired day and enabling the user to differentiate the days that are represented on the timeline.

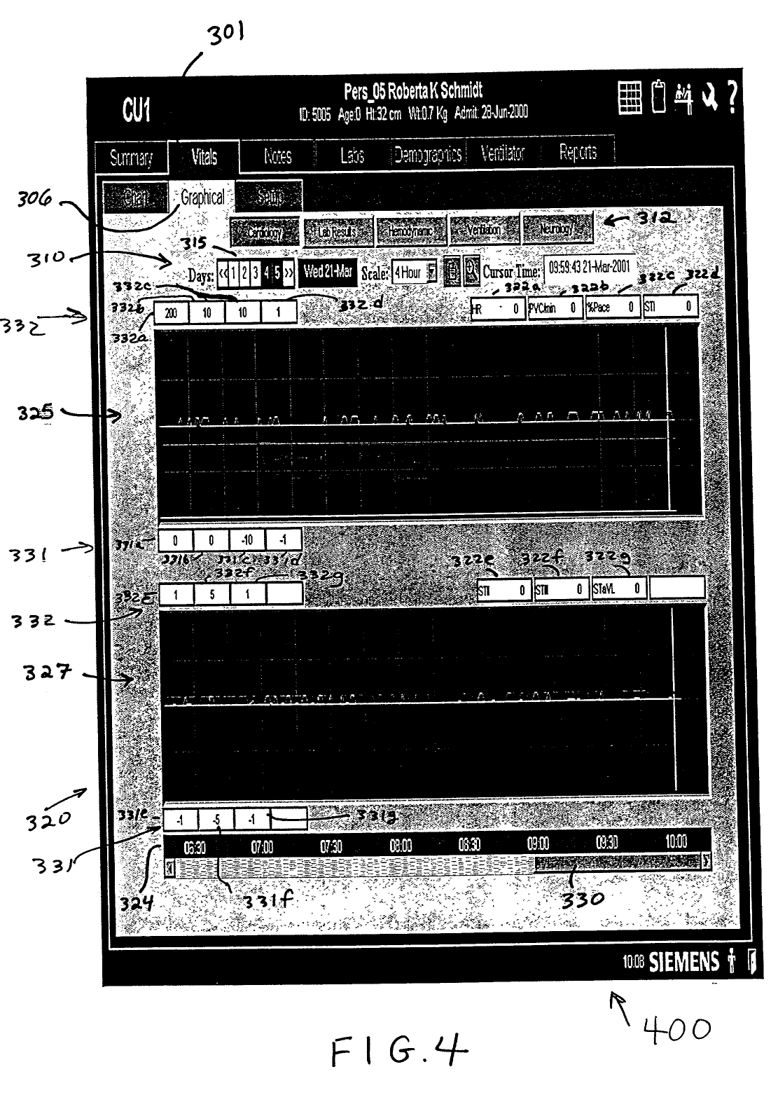

FIG. 4 illustrates an alternative component display within the web enabled GUI system of the present invention for displaying in graphical format medical data associated with particular monitored parameters retrieved and displayed on a web browser of a user computer 26 along a timeline spanning multiple days. For brevity, a discussion of the same functionality associated with the same components shown and discussed with respect to FIG. 3 has been omitted.

FIG. 4 shows display window 400 comprising navigator panel portion 310 and results display window portion 320 containing medical parameter data 322 displayed in graphical format along timeline 324 in response to a user request for access to particular medical parameter data associated with a given patient. In the exemplary embodiment shown in FIG. 4, the medical parameter data is displayed in graphical format when the user selects Graphical icon 306 from the vitals panel 301 and further selects one of the icons labeled generally as 312 and corresponding to particular medical parameters associated with a corresponding one of cardiology, lab results, hemodynamic, ventilation and neurology categories. User selection of the day indicator panel 315 operates as described above with respect to FIG. 3 to enable retrieval and display of all medical parameter data for a given patient associated with the selected day, the immediately preceding day, and immediately succeeding day, that also meet all other search criteria (e.g. category of medical parameter data).

As shown in FIG. 4, the user interface display for displaying the particular medical parameter data operates to collate certain parameters for grouping together for display in a desired order according to predetermined criteria. For example, the embodiment shown in FIG. 4 provides for two displays or trend panels 325, 327 each including a graphical representation of particular patient medical data as a function of time as shown along horizontal timeline 324 located at the bottom of the display window above scrollbar 330. As shown, each trend panel 325, 327 comprises a maximum of 4 trends or sets of medical parameters for display along the graph. Display windows 322a, 322b, . . . , 322g positioned above each of the trend panels identify each of the corresponding medical parameters whose data are graphically displayed along the timeline. Each display window has a particular attribute (such as a color attribute) that corresponds to a same attribute associated with the corresponding graphical data. For example, display window 322a which represents monitored Heart Rate (HR) parameter data, has a red background so as to correspond in one-to-one fashion with the red colored graphical representation of the HR parameter data. The other display windows have a correspondingly distinct color attribute associated with the same color attribute of their particular graphical data to enable a user to distinguish parameter trends. Other attributes are also contemplated, including font, style, geometry and the like.

Parameter range display sets 331, 332 provide minimum (i.e. 331a, 331b, . . . , 331g) and maximum (i.e. 332a, 332b, . . . , 332g) ranges respectively associated with each of the corresponding display window parameters 322a, 322b, . . . , 322g. In a particular embodiment, the range display set is provided with the maximum and minimum range limits 332, 331 located on the left hand side above and below, respectively the graphical parameter data window. As shown in FIG. 4, the maximum and minimum range scale limits for each parameter appear in the differentiated color and in the specific order in which the parameter labels are presented.

Referring again to FIG. 2, in accordance with the present invention, a user request for medical parameter data associated with a given patient admitted into the hospital causes the search engine on server 20 to search and retrieve all data parameters meeting the predetermined search criteria. The user request includes parameters related to the collation and display of the data in a predetermined format and in a selected day range. If a tabular format is requested (step 210) user interface software logic operates to collate and prioritize the retrieved data for display in column fashion (step 212). Otherwise, the user interface software collates and prioritizes the retrieved data for display in graphical fashion. In addition, a timeline representation associated with the data parameters to be displayed is generated and formatted (step 214) for display with the data. Software logic within the user interface allocates color attributes to the timeline, display text areas, and user selection indicator panel for differentiating parameter data over day boundaries (step 216). A menu generator then operates to display a composite window containing patient medical data and parameters together with timeline information and color attributes connecting the data with the selected day.

As discussed herein, the user interface apparatus of the present invention overcomes many of the problems presently associated with existing medical chart systems by providing a user interface apparatus having a scrollable window display for displaying medical parameter data extending beyond a single day (i.e. 24 hour period), while allowing a user to select a desired day and enabling the user to quickly and easily differentiate the days that are represented on the timeline.

It is to be understood that the embodiments and variations shown and described herein are for illustrations only and that various modifications may be implemented by those skilled in the art without departing from the scope of the invention.

What is claimed is:

1. In a network compatible system for displaying medical information derived from a plurality of sources, user interface apparatus comprising:
a communication processor for acquiring via a communication network patient medical data collated over a plurality of days;
a display generator for generating
a day indicator associated with said patient medical data indicating a current day and at least one of, (a) a prior day and (b) a subsequent day relative to said current day, said current day indication having a display attribute; and
a timeline for use in identifying medical data associated with said current day and having a portion associated with said current day, said timeline portion being distinguished using said display attribute; and
a collation processor for prioritizing parameters of said acquired medical data for display in a desired order together with said timeline.

2. The apparatus of claim 1, wherein said timeline is capable of covering periods in excess of one day and includes intra-day time intervals.

3. The apparatus of claim 1, wherein said display attribute comprises at least one of (a) a color, (b) a text or symbol, (c) a text or symbol geometry or style, and (d) a font type.

4. The apparatus of claim 3, wherein said color display attribute is at least one of (a) background color, (b) a text color.

5. The apparatus of claim 1, wherein said prior day or subsequent day indications of said day indicator have a different display attribute than said current day display attribute.

6. The apparatus of claim 5, wherein said different display attribute comprises a different color than a color associated with said current day display.

7. The apparatus of claim 1, wherein said timeline portion associated with said current day is distinguished from another portion of said timeline by means of color.

8. The apparatus of claim 1, wherein said communication network is at least one of an internet or intra-net compatible network.

9. The apparatus of claim 1, wherein said display generator is an internet browser.

10. A network compatible method for displaying medical information derived from a plurality of sources, comprising steps of:
acquiring medical parameters associated with a patient over a plurality of days;
prioritizing certain of said medical parameters acquired for display in a desired order along a timeline associated with a current day and at least one of a prior day and a subsequent day; and
allocating an attribute for display along a portion of the timeline associated with the current day to distinguish those medical parameters associated with the current day.

11. The method of claim 10, further comprising the step of providing at a first area of the display an indicator of the current day, said indicator having a color attribute for identifying the current day from said prior or subsequent days.

12. The method of claim 11, wherein said color attribute comprises a background color.

13. The method of claim 11, wherein said timeline covers periods in excess of one day and includes intra-day time intervals.

14. The method of claim 11, further comprising the step of providing at said first area of the display a scrollable window for selecting said current day from said plurality of days.

15. The method of claim 14, further comprising the step of providing in said scrollable window a color attribute associated with at least one of said prior and subsequent day distinguishable from a color attribute associated with said current day.

16. The method of claim 15, wherein said medical parameters are acquired over at least one of an internet or intra-net compatible network.

17. An internet compatible method for displaying medical data associated with a patient derived from a plurality of sources, comprising steps of:
acquiring said medical data over a plurality of days;
prioritizing certain of said medical parameters acquired for display in a desired order along a timeline associated with a user selected day and at least one of a prior day and a subsequent day;
displaying in a first area a scrollable window containing at least a subset of said plurality of days including said user selected day;
allocating an attribute associated with said user selected day for distinguishing said user selected day from all other of said plurality of days; and
allocating the same attribute for display along a portion of the timeline associated with the user selected day to distinguish those medical parameters associated with the user selected day.

18. The method of claim 17, wherein the step of allocating an attribute comprises allocating a color attribute.

19. The method of claim 18, wherein the step of allocating a color attribute comprises providing a background color.

20. The method of claim 17, wherein said timeline covers periods in excess of one day and includes intra-day time intervals.
